(19) United States
(12) Patent Application Publication
(10) Pub. No.: US 2009/0277561 A1
(43) Pub. Date: Nov. 12, 2009

(54) PRESSURE-SENSITIVE ADHESIVE TAPES FOR BONDING PRINTING PLATES AND METHODS OF PROVIDING THEM

(75) Inventors: Kai Ellringmann, Hamburg (DE); Christian Ring, Stelle (DE); Thorsten Krawinkel, Hamburg (DE); Jochen Fiencke, Hamburg (DE)

Correspondence Address: NORRIS, MCLAUGHLIN & MARCUS, P.A., 875 THIRD AVE, 18TH FLOOR, NEW YORK, NY, 10022, US

(73) Assignee: tesa SE, Hamburg (DE)

(21) Appl. No.: 12/434,707

(22) Filed: May 4, 2009

(30) Foreign Application Priority Data
May 9, 2008 (DE) 10 2008 023 021.9
May 15, 2008 (DE) 10 2008 023 741.8

(51) Int. Cl. B32B 37/12; B32B 7/12; C09J 7/02

(52) U.S. Cl. 156/60; 428/317.3

(57) ABSTRACT

The invention relates to the use of a pressure-sensitive adhesive comprising at least one resin-polymer blend of at least 50% by weight of one or more block copolymers comprising polymer blocks based on vinylaromatics and comprising polymer blocks based on 1,3-dienes and not more than 50% by weight of at least one tackifier resin for an adhesive tape for bonding flexible printing plates to printing cylinders or printing sleeves.

The invention relates to pressure-sensitive adhesive tapes comprising at least one layer of a pressure-sensitive adhesive (PSA) which possesses a very low level of peel increase to polar surface, is readily repositionable, and, after bonding to a printing cylinder, exhibits low levels of edge lifting of the printing plate and of the adhesive plate-mounting tape/printing plate assembly, and to the use of pressure-sensitive adhesive tapes (PSA tapes) of this kind for bonding printing plates.

Within the printing industry there is a variety of techniques known for transferring designs to paper, for example, by means of print originals. One possibility is that known as flexographic printing. One embodiment of flexographic printing, in turn, is the use of multi-layered photopolymer printing plates having a flexible substructure, this type of printing having been part of the prior art for some considerable time. These printing plates are composed of a plurality of layers of different polymeric materials each with specific functions. For example, the “nyloflex ACE” printing plates from the FlintGroup company have at least two layers, namely a light-sensitive relief layer and, beneath it, a stabilizing film.

In the flexographic printing process, flexible printing plates are bonded to printing cylinders. This adhesive bonding is generally carried out using double-sided pressure-sensitive adhesive tapes (PSA tapes), on which very stringent requirements are imposed. For the printing process, the PSA tape is required to have a certain hardness but also a certain elasticity. These properties must be set very precisely in order that the printed image produced yields the desired result in accordance with the requirements. Further stringent requirements are imposed on the PSA, where the bond strength must likewise be sufficiently high that the printing plate does not detach from the double-sided PSA tape, or the PSA tape from the cylinder. This must be so even at elevated temperatures of 40-60° C. and at relatively high printing speeds. In addition to this property, however, the PSA is also required to possess reversible adhesion properties, since frequently it is necessary to bond printing plates and then detach them again for repositioning since usually the printing plates are used a number of times. This detachability ought to exist even for an adhesive bond over a relatively long period of time (up to 6 months); here, the printing plate ought to be able to be removed again without destruction. Furthermore, there should be no residues on the printing plate or on the cylinder.

In summary, then, very stringent requirements are imposed on the double-sided PSA tapes that are suitable for this utility.

U.S. Pat. No. 4,380,956 describes a process for fixing a printing plate for the flexographic printing process. PSAs are used for that process too, but have not been specified in any greater detail.

GB 1,533,431 claims a double-sided PSA tape including an elastomeric layer which in turn has been foamed by fragile air bubbles. The air bubbles are destroyed under pressure during the flexographic printing application.

U.S. Pat. No. 4,574,697 claims double-sided PSA tapes comprising as their carrier material a flexible polyurethane foam affixed to a PET (polyethylene terephthalate) film. The external layers are composed of PSAs.

The PSA tape described is said to be reversible and to be removable from the printing cylinder and from the printing plate. A similar product structure has been described in EP 0 206 760. There the flexible foam carrier used was a polyethylene foam.

U.S. Pat. No. 4,574,712 describes, in analogy to U.S. Pat. No. 4,574,697, a similar PSA tape construction. Here there is a restriction on the PSAs to the effect that the bond strength to the printing plate and to the printing cylinder should be lower than to the carrier film and the carrier foam.

U.S. Pat. No. 3,983,287 describes a laminate whose carrier material comprises an incompressible elastomer. Compressibility is achieved by means of beads which are destroyed under pressure and which therefore produce flexibility. U.S. Pat. No. 5,613,942 describes PSA tapes which are especially suitable for bonds on wet surfaces. It is also said that such PSA tapes are suitable for bonding printing plates.

U.S. Pat. No. 5,476,712 likewise describes a double-sided PSA tape which is used in the flexographic printing process. This PSA tape comprises, in turn, a thermoplastic elastomer, the structure present in this case being a cellular structure produced by means of expanding microparticles.

In the cases referred to above, a very large number of different PSAs are employed. Natural rubber adhesives possess good tack properties but lack great shear strength at room temperature and age as a result of degradation via the double bonds present in the polymer.

For the bonding of printing plates (also referred to as plates below) to printing cylinders it is typical to use adhesives based on acrylate. These have the advantage that they possess a high initial tack and can be easily demounted again. Nevertheless, these adhesives have an increased tendency towards edge lifting.

In the market there are also adhesive tapes based on styrene block copolymers for this application, but these adhesive tapes as well exhibit severe edge lifting, particularly when thick plates 2.54 mm in thickness are used, as is the case particularly in long-duration printing operations. The edge lifting increases with the thickness and stiffness of the printing plates.

The phenomenon of edge lifting is a problem which is known for virtually all current commercial adhesive printing plate tapes, and results from the fact that the flexible printing plates, after the operation of bonding to a printing cylinder—and the deformation this inevitably involves—exhibit a propensity to resile into the planar area. The propensity towards edge lifting is dependent on parameters which include the cylinder diameter, the thickness and nature of the printing plate, the presence of a printing plate margin which is not used for printing (and which in that case is thinner and exhibits lower resilience forces), the print design at the plate margin (if the printing plate is printed over the full area it typically has the highest resilience forces), the cleaning of the reverse of the printing plate prior to mounting on the cylinder, the pressure applied to the plates in the course of bonding, and on further parameters.

Where two or more printing plates are used simultaneously, the requirements imposed on the gap between the printing plates, which are typically bonded seamlessly, become ever greater, particularly if large-format prints are to be produced in which the transition is to be invisible. Flexographic printing (i.e. printing using printing plates) is increasingly competing with other processes such as that of gravure printing, for example, and so the aforementioned requirements are gaining in significance. Besides the fact that the gap must become increasingly small (less visible for the printed image), there is also no longer a possibility of leaving a non-print margin.

Printers are attempting to master these problems at present by carrying out printing processes with two or more worksteps, but this entails considerable inconvenience and additional costs.

It is an object of the invention to remedy this situation and to provide an adhesive tape which exhibits no edge lifting even after prolonged storage at slightly elevated temperatures, can be removed again easily and ideally also allows effective repositionability.

This object is achieved surprisingly as described in the main claim.

An adhesive is used which comprises a polymer-resin blend with a high fraction of block copolymers, of more than 50% by weight in particular, and a low resin fraction, the block copolymers being copolymers based on vinylaromatics.

The adhesive can be realized at its most simple by the polymer-resin blend alone; in developments of the adhesive of the invention, however, it is also possible for further additives and adjuvants to be added.

These adhesives possess only a moderate bond strength, but show no tendency towards peel increase on the substrate and are therefore easily repositionable. Surprisingly, adhesive tapes equipped with an adhesive of the invention exhibit very little edge lifting or none at all.

Pressure-sensitive adhesives employed are those based on block copolymers containing polymer blocks formed from vinylaromatics (A blocks), such as styrene, for example, and blocks formed by polymerization of 1,3-dienes (B blocks), such as butadiene and isoprene or a copolymer of butadiene and isoprene, for example. With advantage it is also possible for mixtures of different block copolymers to be employed. With further advantage it is possible to use products which are partly or fully hydrogenated.

The block copolymers used may in particular have a linear A-B-A structure. It is likewise possible to employ block copolymers of radial form and also star-shaped and linear multiblock copolymers. As a further component it is possible to use A-B diblock copolymers. In accordance with the invention it is also possible with outstanding effect to use mixtures of block copolymers with different architectures.

Preference is given to using those block copolymers which possess a polyvinylaromatics content of at least 20% by weight.

Able to be used to particularly outstanding effect are styrene-isoprene-styrene block copolymers (SIS) and/or styrene-butadiene-styrene block copolymers as a polymer component of the pressure-sensitive adhesive used in accordance with the invention.

Tackifiers used are tackifier resins which are compatible with the elastomer block of the vinylaromatic block copolymers. Suitable tackifier resins include unhydrogenated, partially hydrogenated or fully hydrogenated resins based on rosin or rosin derivatives, hydrogenated or unhydrogenated polymers of dicyclopentadiene, unhydrogenated or partly, selectively or fully hydrogenated hydrocarbon resins based on C-5, C-5/C-9 or C-9 monomer streams, and/or hydrogenated or unhydrogenated polyterpene resins based on α-pinene and/or β-pinene and/or δ-limonene. Aforementioned tackifier resins can be used both alone and in a mixture.

The use concentrations for the block copolymer are above 50% by weight to 75%, more particularly in the range between 55% by weight and 65% by weight, based in each case on the resin-polymer blend. With corresponding advantage the resins are chosen preferably in a fraction of 25% to 50% by weight, very preferably in a fraction of 35% to 45% by weight.

Further additives which can be used with outstanding effect for the pressure-sensitive adhesives are, in particular, the following compounds:
primary antioxidants, such as sterically hindered phenols, for example
secondary antioxidants, such as phosphites or thioethers, for example
in-process stabilizers, such as C-radical scavengers, for example
light stabilizers, such as UV absorbers or sterically hindered amines, for example
processing assistants
endblock reinforcer resins and
if desired, further polymers of preferably elastomeric nature; correspondingly useful elastomers include, among others, those based on pure hydrocarbons, for example unsaturated polydienes, such as natural or synthetic polyisoprene or polybutadiene, substantially chemically saturated elastomers, such as, for example, saturated ethylene-propylene copolymers, α-olefin copolymers, polyisobutylene, butyl rubber, ethylene-propylene rubber and also chemically functionalized hydrocarbons, such as, for example, halogen-containing, acrylate-containing or vinyl ether-containing polyolefins, to name but a few
inorganic fillers, such as chalk and/or silicates, for example.

A feature of the pressure-sensitive adhesive systems of the invention is that they meet the stated profile of requirements and in particular have the following advantages:
multiple reusability (repositionability) of the PSA tapes,
reversibility on different surfaces,
residue-free redetachability from the substrate,
little peel increase even on polar surface,
minimized or no edge lifting after bonding on the printing cylinder.

In one advantageous embodiment of the adhesive tape of the invention said tape is constructed at least of a carrier layer and of one layer of pressure-sensitive adhesive on each of the two sides of the carrier layer.

In particular the carrier of the adhesive tape of the invention is a film, a foam or a composite of two or more films, two or more foams or at least one film and at least one foam, the corresponding carrier or assembly bearing double-sidedly self-adhesive coatings, and at least the side facing the printing plate being equipped with the PSA of the invention. The PSA of the invention can be used advantageously for both layers of PSA.

Outstandingly suitable in accordance with the invention is a double-sided adhesive tape, which comprises a foamed carrier, a polymer film on one side of the foamed carrier, and a layer of a PSA on each of the two sides of the adhesive tape, at least one of the external layers of PSA being a crosslinked PSA of the invention, but more particularly both layers of PSA being PSAs of the invention.

Where a composite of at least one film and at least one foamed material (“foam”) is used as carrier, these carrier layers, in one advantageous procedure, can be laminated together by an adhesive to produce a carrier assembly. In a further embodiment, the layers may be joined to one another by heat sealing. To produce the carrier assembly an alternative possibility is to employ the other methods known in the art for extensively joining two layers, particularly of polymeric nature.

On the side of the PSA tape facing the printing cylinder it is possible with advantage to use the PSA of the invention, although in principle here it is also possible to use other PSAs known to a person skilled in the art. Suitability is possessed accordingly, for example, by rubber-based PSAs, synthetic rubber PSAs, PSAs based on polysilicones, polyurethanes, polyolefins or polyacrylates.

As film-based carriers it is possible to employ the materials that are familiar to a person skilled in the art, especially polyesters, polyethylene terephthalate (PET), polyethylene (PE), polypropylene (PP), biaxially oriented polypropylene (BOPP), polyvinyl chloride (PVC) etc. This listing should not be understood as being exhaustive. Particular preference is given to using a film of polyethylene terephthalate.

Foam carriers suitable with particular advantage are polymer foams, the carrier foams being composed, for example, of polyolefins, more particularly polyethylene or polypropylene, of polyurethanes or of polyvinyl chloride.

Where foams are used as carrier materials it is especially advantageous additionally to provide at least one stabilizing carrier on at least one side of the foamed carrier, to produce a carrier assembly as outlined above. The stabilized carrier may be more particularly a paper or a film, especially a film of polyester, polyethylene terephthalate, polyethylene, polypropylene, biaxially oriented polypropylene or polyvinyl chloride.

Advantageously it is possible for a stabilizing carrier to be provided on both sides of the foam carrier.

In general it is possible to improve the PSA anchorage by roughening the carrier material. One way of roughening and of chemically modifying the polymer structure is via the wet-chemical etching of the carrier material. As well as etching, pre-treatment may take place in other ways as well.

For instance, the carrier materials may be pretreated chemically and physically for the purpose of improving the anchorage. For physical treatment, the film is treated preferably by flame or corona or plasma. For chemical pre-treatment, the carrier material is provided with a prime coat, and in one particularly preferred embodiment, reactive prime coats are used. Prime coat materials that are suitable include, for example, reactive primers.

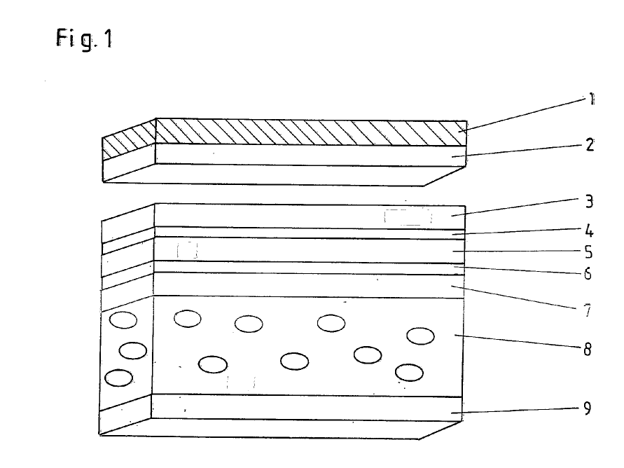

For use as a double-sided pressure-sensitive adhesive tape for the bonding of printing plates, the PSA tape in one particularly preferred embodiment of the invention possesses the product construction in FIG. 1.

The adhesive tape is used to bond a printing plate composed of a PET-film 2 and a layer of a photopolymer 1.

Layers 3 to 9 form a double-sidedly adhesive plate-mounting tape which by virtue of its foamed carrier 8 is compressible and elastic.

Beginning from the side by means of which the plate is bonded, the adhesive tape is composed of the following individual sections:
3 PSA for anchoring the plate
4 the roughened top surface of the PET film 5
5 film of polyethylene terephthalate (PET)
6 the roughened bottom surface of the PET film 5
7 PSA for anchoring the foamed carrier 8 on the film of polyethylene terephthalate (PET) 5
8 foamed carrier
9 PSA for anchoring on the printing cylinder.

In the printing industry specifically it is important that the adhesive tapes employed here have a high flexibility, i.e. are able to alter their thickness to a certain extent when pressure is applied and to regain their original form when the load is removed.

It is advantageous, furthermore, if the foamed carrier 8 is composed of polyolefin(s), polyvinyl chloride (PVC) or polyurethane (PU). One particularly preferred embodiment uses foamed polyethylenes and polypropylenes. It is further preferred if the surfaces of the foamed carrier have been physically pretreated, more particularly corona-pretreated.

With further preference the polyethylene terephthalate (PET) film has a thickness of 5 μm to 500 μm, preferably 5 μm to 60 μm.

Additionally the adhesive tape of the invention can be provided on one or both sides with a liner of paper or of corresponding film, more particularly a double-sidedly siliconized paper or a double-sidedly siliconized film or a silicone film, in order to ensure prolonged storage and convenient handling in the course of use.

On account of its specific properties, the double-sided adhesive tape of the invention can be used outstandingly for fixing printing plates, especially multi-layered photopolymer printing plates, to printing cylinders or sleeves.

On account of its particular configuration, particularly with the bond strengths matched to the printing plate, the adhesive tape of the invention is outstandingly suitable for bonding the printing plates to the printing cylinders. On the one hand it is possible to reposition the printing plates a number of times before printing is commenced; on the other hand, however, firm bonding of the plate during the printing operation is ensured.

The printing plate bonded using the PSA tape provided with the PSA of the invention can be removed from the PSA tape without any damage whatsoever, and in particular can also be removed without residue.

Peeling of the carrier layer of the plate, or the formation of unwanted creases in the plate during removal, do not occur. Nor are there any residues left after the adhesive tape has been removed from the printing cylinder.

The adhesive tape of the invention is also outstandingly suitable for bonding flexible printing plates to printing sleeves.

Experiments:

The advantages of the adhesive tape of the invention are described below in a number of experiments. The following test methods were employed for evaluating the technical properties of the PSAs prepared.

Test Methods:

Bond Strength

The peel strength (bond strength) was tested in accordance with PSTC-1. A PSA layer is applied at 30 g/m² to a PET film 23 μm thick.

A strip of this specimen 2 cm wide is bonded to a steel plate and rolled over back and forth three times using a 2 kg roller. The plate is clamped in and the PSA strip is peeled from its free end on a tensile testing machine under a peel angle of 180° and at a speed of 300 mm/min.

In the course of this procedure a measurement is made of the bond strength in one case directly after bonding and in another case after storage at room temperature for 72 h.

The bond strength on polyethylene was determined as follows: the defined substrate (bond strength plate) used was a polyethylene plate which had been produced as a test plate by injection moulding from Basell Hostalen GC7260 HDPE pellets. Prior to measurement, this plate was cleaned with ethanol. As the sample for investigation, a standard polyester carrier with a thickness of 23 μm was coated on one side with the respective self-adhesive (self-adhesive coat weight: 50 g/m²). A strip of the coated standard polyester carrier 20 mm wide was pressed under load (2 kg) onto the substrate. Immediately thereafter the adhesive tape was peeled from the substrate at an angle of 180° and a speed of 300 mm/min and the force required to accomplish this, at room temperature, was measured. The measurement value (in N/cm) was obtained as the average from three individual measurements. To calibrate the measurement technique, a commercial test adhesive tape for the testing of non-adhesive coatings (type “tesa 7475” from tesa AG; bond strength to steel, according to specification: 31.25 N/25 mm) was investigated by this measuring technique; the bond strength to the polyethylene test plate found in that case was 4.5 N/cm.

Edge Lifting:

Steel printing cylinders were provided with a double-sided adhesive tape with a construction corresponding to FIG. 1, the stabilizing film used being an etched PET film of 23 μm and the foam used being a 500 μm PE-EVA foam (polyethylene-ethylene-vinyl acetate) having a density of 270 kg/M³. The adhesive used on both sides, in other words facing both the steel cylinder and the printing plate, was the respective composition from Examples B1 to B5 and C6 and C7, in a thickness of 30 g/m².

Bonded to the external, inventive layer of adhesive (reference number 3 in FIG. 1) of the adhesive tape applied to the steel cylinder (bonding of the adhesive tape to the printing cylinder mediated by the adhesive 9 in FIG. 1), after removal of the release paper, was a DuPont Cyrel HOS printing plate with a thickness of 2.54 mm.

The specimens were left to stand at room temperature for 3 days in the bonded state. Subsequently the edge lifting was measured, in mm.

Detachability:

The bonded printing plates described above were removed by hand after a peel increase time of 3 days, and the detachability was observed subjectively; the categories found for the detachability were easy, acceptable, difficult and very difficult.

Sample Preparation

The preparation and processing of the PSAs can take place from solution, from dispersion and from the melt. Preferred preparation and processing methods are from solution and from the melt.

Production of the Specimens:

The constituents are dissolved in a 50:50 mixture of toluene and benzine, to give a solids content of 40%. The specimens are then coated out onto an etched PET film 23 μm thick and are dried at 100° C. to leave a weight per unit area of 30 g/cm² of adhesive.

All of the examples were admixed with 0.5 part of Irganox® 1010 as ageing inhibitor and 0.5 part of Tinuvin® P as UV absorber.

For the composition of the examples, see Table 1 (all amounts in % by weight).

TABLE 1

| | B1 | B2 | B3 | B4 | B5 | C6 |
|---|---|---|---|---|---|---|
| Kraton ® D 1165 | 55 | | | | | |
| Kraton ® D 1118 | | 30 | | 20 | 20 | 15 |
| Kraton ® D 1102 | | 30 | 60 | | 40 | 30 |
| Kraton ® D 1101 | | | | 40 | | |
| Pentalyn ® H-E | 35 | 35 | | | | 45 |
| Regalite ® R 1090 | | | 40 | | 35 | |
| Dercolyte ® A 115 | | | | 30 | | |
| Picco ® A 10 | 10 | | | | | 10 |
| Foralyn ® 5020 | | 5 | | | | |
| Wingtack ® 10 | | | | 10 | | |
| Shellflex ® 371 | | | | | 5 | |

Properties of the raw materials employed:

| | |
|---|---|
| Kraton ® D 1165 | SIS, about 16% by weight diblock, block |
| | polystyrene content: 30% by weight, Kraton |
| | polymers |
| Kraton ® D 1118 | SBS, about 76% by weight diblock, block |
| | polystyrene content: 31% by weight, Kraton |
| | polymers |
| Kraton ® D 1102 | SBS, about 14% by weight diblock, block |
| | polystyrene content: 30% by weight, Kraton |
| | polymers |
| Kraton ® D 1101 | SBS, about 18% by weight diblock, block |
| | polystyrene content: 31% by weight, Kraton |
| | polymers, higher molecular weight than |
| | Kraton D 1102 |
| Pentalyn ® H-E | hydrogenated rosin ester, softening point |
| | (Ring & Ball) about 110° C., Eastman |
| Regalite ® R 1090 | hydrogenated hydrocarbon resin on C-9 basis, |
| | softening point (Ring & Ball) about 90° C., |
| | Exxon Mobil |
| Dercolyte ® A 115 | alpha-pinene resin, softening |
| | temperature: about 115° C., DRT |
| Picco ® A 10 | liquid hydrocarbon resin, Eastman |
| Foralyn ® 5020 | liquid rosin, Eastman |
| Wingtack ® 10 | liquid hydrocarbon resin, Goodyear |
| Shellflex ® 371 | naphthenic oil, Shell |
| Irganox ® 1010 | sterically hindered phenol; Ciba Additives |
| Tinuvin ® P | UV absorber, Ciba Additives |

The softening points were measured by the method of DIN EN 1427:2007, using the resin under test instead of bitumen.

### EXAMPLE C7

A 2 L glass reactor conventional for free-radical polymerizations was charged with 8 g of acrylic acid, 372 g of 2-ethylhexyl acrylate, 20 g of isobornyl acrylate and 170 g of acetone: special boiling point spirit 60/95 (1:1). After nitrogen gas had been passed through the reactor with stirring for 45 minutes, the reactor was heated to 58° C. and 0.2 g of azoisobutyronitrile (AIBN, Vazo® 64, DuPont) in solution in 10 g of acetone was added. Subsequently the external heating bath was heated to 75° C. and the reaction was carried out constantly at this external temperature. After a reaction time of 1 h a further 0.2 g of AIBN in solution in 10 g of acetone was added. After a reaction time of 5 hours, 0.8 g of bis(4-tert-butylcyclohexanyl)peroxydicarbonate (Perkadox® 16, Akzo Nobel) in solution in 10 g of acetone was added. After 6 hours the batch was diluted with 100 g of special boiling point spirit 60/95. After a reaction time of 7 hours, 0.8 g of bis(4-tert-butylcyclohexanyl)peroxydicarbonate (Perkadox® 16, Akzo Nobel) in solution in 10 g of acetone was added.

After 10 hours the batch was diluted with 150 g of special boiling point spirit 60/95. After a reaction time of 24 h the reaction was discontinued and the batch was cooled to room temperature. Subsequently the polyacrylate was blended with 0.6% by weight of aluminium acetylacetonate (3% strength solution in acetone) and diluted to a solids content of 30% with special boiling point spirit 60/95, and then coated from solution onto a PET film. After drying at 120° C. for 30 minutes, the coat weight was 30 g/m².

The exemplary PSA strips were found to have the following technical data:

| | Bond | Bond | | | | |
|---|---|---|---|---|---|---|
| | strength to | strength to | Bond | Holding power | | |
| PSA | steel, | steel, after | strength | at room | Edge | |
| Example | immediate, | 72 h, in | to PE in | temperature in | lifting in | |
| No. | in N/cm | N/cm | N/cm | minutes | mm | Detachability |
| B1 | 5.8 | 6.3 | 4.1 | >10 000 | 0 | Acceptable |
| B2 | 6.2 | 6.5 | 3.8 | >10 000 | 0 | Easy - |
| | | | | | | acceptable |
| B3 | 5.3 | 5.7 | 3.4 | >10 000 | 0 | Easy - |
| | | | | | | acceptable |
| B4 | 5.9 | 6.5 | 3.8 | >10 000 | 0 | Easy |
| B5 | 4.8 | 5.2 | 3.1 | >10 000 | 0 | Easy |
| C6 | 8.2 | 9.3 | 4.9 | >10 000 | 0 | Very difficult |
| C7 | 2.2 | 3.1 | | | 55 | Easy |

It is noted that the adhesive based on acrylate (C7), although easily detachable, nevertheless also exhibits severe edge lifting.

The adhesive with the small amount of vinylaromatic block copolymer (C6) does possess a high bond strength and shows no edge lifting, but can be detached only with great difficulty and not at all in the case of relatively large printing plates.

With a high fraction of elastomer (vinylaromatic block copolymer), in particular of more than 50% by weight (based on the resin-block copolymer mixture), there is likewise no edge lifting, and yet the printing plates can be removed much more easily again, without residue, after use; in this regard, compare the inventive Examples B1 to B5.

1. A method for bonding flexible printing plates to printing cylinders or printing sleeves which comprises bonding said flexible printing plates to said printing cylinders or said printing sleeves with an adhesive tape having a a pressure-sensitive adhesive comprising at least one resin-polymer blend of at least 50% by weight of one or more block copolymers comprising polymer blocks of vinylaromatics and polymer blocks of 1,3-dienes and not more than 50% by weight of at least one tackifier resin.

2. Double-sided adhesive tape comprising at least one foamed carrier, at least one polymer film on one side of the foamed carrier and one layer of a pressure-sensitive adhesive on each of the two sides of the adhesive tape, wherein at least one of the external layers of pressure-sensitive adhesive is a composition comprising at least one resin-polymer blend of at least 50% by weight of one or more block copolymers comprising polymer blocks of vinylaromatics and polymer blocks of on 1,3-dienes and not more than 50% by weight of at least one tackifier resin.

3. Adhesive tape according to claim 2, wherein the amount of block copolymer in the resin-polymer blend is 55% to 65% by weight.

4. Adhesive tape according to claim 2, wherein the amount of resin in the resin-polymer blend is 35% to 45% by weight.

5. Adhesive tape according to claim 2 wherein the resins are resins formed of rosin or rosin derivatives, hydrogenated or unhydrogenated polymers of dicyclopentadiene, unhydrogenated or partially, selectively or fully hydrogenated hydrocarbon resins based on C-5, C-5/C-9 or C-9 monomer streams, hydrogenated or unhydrogenated polyterpene resins of α-pinene and/or β-pinene and/or δ-limonene.

6. Adhesive tape according to claim 2, wherein the block copolymers possess a polyvinylaromatics content of at least 20% by weight.

7. Adhesive tape according to claim 2, wherein said vinylaromatics are styrene.

8. Adhesive tape according to claim 2, wherein said 1,3-dienes are butadiene and/or isoprene.

9. (canceled)
